(19) United States
(12) Patent Application Publication
(10) Pub. No.: US 2007/0146583 A1
(43) Pub. Date: Jun. 28, 2007

(54) Reflective light barrier

(75) Inventors: Hubertus Dreher, Elzach (DE); Werner Schuler, Bleibach (DE); Axel Hauptmann, Waldkirch (DE); Stefan Jacob, Denzlingen (DE)

Correspondence Address: NATH & ASSOCIATES, PLLC, 112 South West Street, Alexandria, VA, 22314, US

(73) Assignee: SICK AG, Waldkirch (DE)

(21) Appl. No.: 11/526,569

(22) Filed: Sep. 26, 2006

(30) Foreign Application Priority Data
Sep. 28, 2005 (DE) 10 2005 046 554.4

(51) Int. Cl. G02F 1/1335

(52) U.S. Cl. 349/106

(57) ABSTRACT

The invention relates to a reflective light barrier, with an optical transmitter (3) and an optical receiver (4) positioned on one side of the surveillance area, and a reflector positioned on the other side, which reflector modifies the polarization of the light upon reflection, where at least one optical element (1, 2, 7, 7a, 7b) and one polarizing filter (11, 12) are positioned both between the optical transmitter (3) and the reflector, and between the optical receiver (4) and the reflector, and where the polarization planes (13, 14) of the two polarizing filters (11, 12) intersect each other, such that at least one of the two polarizing filters (11, 12) is extrusion-coated with optically transparent material, either fully and/or on the back, and such that the optically transparent material forms at least one of the optical elements (1, 2, 7, 7a, 7b).

Reflective light barriers are used to identify persons or objects which have entered the surveillance area covered by the reflective light barrier. An optical transmitter and an optical receiver are positioned on one side of the area being monitored, while a reflector is positioned on the other side of the monitored area. The emitted beam of rays is reflected by the reflector into the optical receiver, which detects the incident ray beam. If an object or person is located in the surveillance area of the reflective light barrier, the ray beam is interrupted. If reflecting objects enter the surveillance area, these objects may also, under corresponding conditions, reflect the emitted ray beam into the optical receiver, with the result that the optical receiver detects an incident ray beam and the light barrier is not activated. To also permit the detection of such reflecting objects at least one optical element and one polarizing filter are positioned both at the optical transmitter and at the optical receiver, in such a way that the polarization planes of the two polarizing filters intersect. The reflector is so designed as to modify the polarization of the light upon reflection, e.g., so that the polarization plane rotates or the light is depolarized. During its passage through the polarizing filter positioned in front of the optical transmitter, the emitted ray beam is thus polarized in a preferred direction, and this direction of polarization is modified upon reflection in the reflector. However, the second polarizing filter, which is positioned in front of the optical receiver, is only able to admit light that precisely exhibits the polarization demanded by the polarizing filter. This is only the case when the emitted ray beam is reflected by the reflector, which at least partially rotates the light's direction of polarization into the polarization plane of the second polarizing filter. If, contrariwise, the emitted ray beam is reflected by a reflecting object which has entered the surveillance area zone, its polarization hardly changes and the second polarizing filter prevents the reflected ray beam from entering the optical receiver. This kind of reflective light barrier is described, e.g., in DE 28 24 583 C3.

In this reflective light barrier the assembly process for the reflective light barrier is laborious, since a polarizing filter and at least one optical element must be mounted in the optical path at both the optical transmitter and the optical receiver and these elements must be precisely oriented. Furthermore, the polarizing filters are sensitive to moisture, and when a high degree of moisture is present the filter effect is diminished and the reflective light barrier loses its full functioning capability.

The goal of the invention, therefore, is to provide a reflective light barrier that is easy to assemble.

This goal is achieved with a reflective light barrier exhibiting the characterizing features of patent claim 1.

Advantageous embodiments and elaborations of the invention are indicated in the secondary claims.

The invention specifies that at least one of the two polarizing filters is extrusion-coated, fully or on the back, with optically transparent material, such that the optically transparent material forms the one or more optical elements. By coating the back of the polarizing filter with the optically transparent material which forms the optical element, the polarizing filter is positioned directly on the optical element and forms a unit with the latter, thereby simplifying the assembly process, inasmuch as only one element must be mounted, instead of two. In particular, the polarizing filter is correctly oriented toward the corresponding optical element by its position in the injection mold, without the need for further assembly. Furthermore, structural components, particularly gripping devices, can be reduced in number since only one element has to be mounted in the gripping device, and this results in reduced manufacturing costs. If the polarizing filter is also extrusion-coated on its circumferential rim, this means in addition that the sensitive edges of the polarizing filter, which are particularly susceptible to moisture, will be sealed and protected from damage, particularly damage resulting from the penetration of moisture.

It is preferable for both two polarizing filters to be coated and/or back-coated with optically transparent material, thereby further simplifying the assembly process and lowering the manufacturing costs.

In a particularly preferred embodiment of the invention both polarizing filters are jointly coated and/or back-coated with optically transparent material. The two polarizing filters are thus jointly positioned in one injection molding part, which forms the two optical elements required for the given polarizing filter. Thus the manufacturing process is further simplified. The special advantage afforded by this embodiment, however, rests in the fact that the polarizing filters are oriented relative to each other during the manufacturing process, and not later, and an involved alignment is not called for during assembly.

In an advantageous elaboration of the invention the optical element is a lens or part of a face-plate. As a rule, at least one lens for focusing the transmitted or incident light is positioned as an optical element in the optical path of the optical transmitter and the optical receiver, as is a face-plate to cover the housing containing the components needed for the reflective light barrier. The polarizing filters can thus be connected either to the lens or to the face-plate (or to a part of the face-plate) of an element to be mounted.

An advantageous feature rests in the fact that the polarizing planes of the two polarizing filters run perpendicular to each other, since this permits the reflector to have a particularly simple design and allows the easy mounting of the polarizing filters.

In a preferred elaboration of the invention at least one of the two polarizing filters takes the form of polarizing foil, ideally with a thickness of 0.1 mm to 0.5 mm. This foil is particularly suited for being back-coated with an optically transparent material. It is advantageous for this optically transparent medium to be a plastic, ideally an easily flowing plastic. Such materials are particularly suited for use in an injection molding process.

The invention will next be described on the basis of exemplary embodiments depicted in the following figures. Shown are:

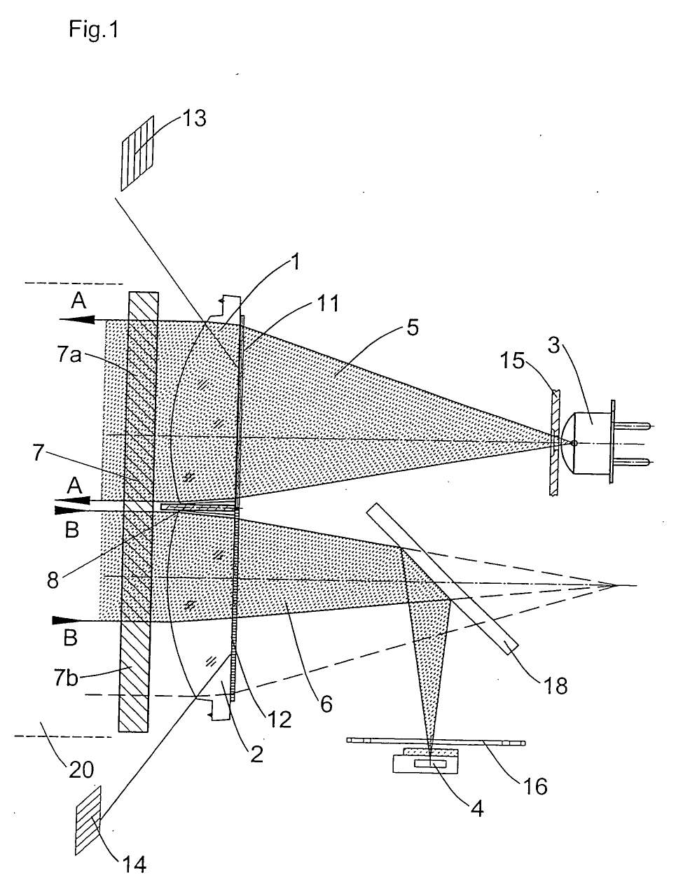

FIG. 1 a schematic depiction of an initial exemplary embodiment of the reflective light barrier in accordance with the invention

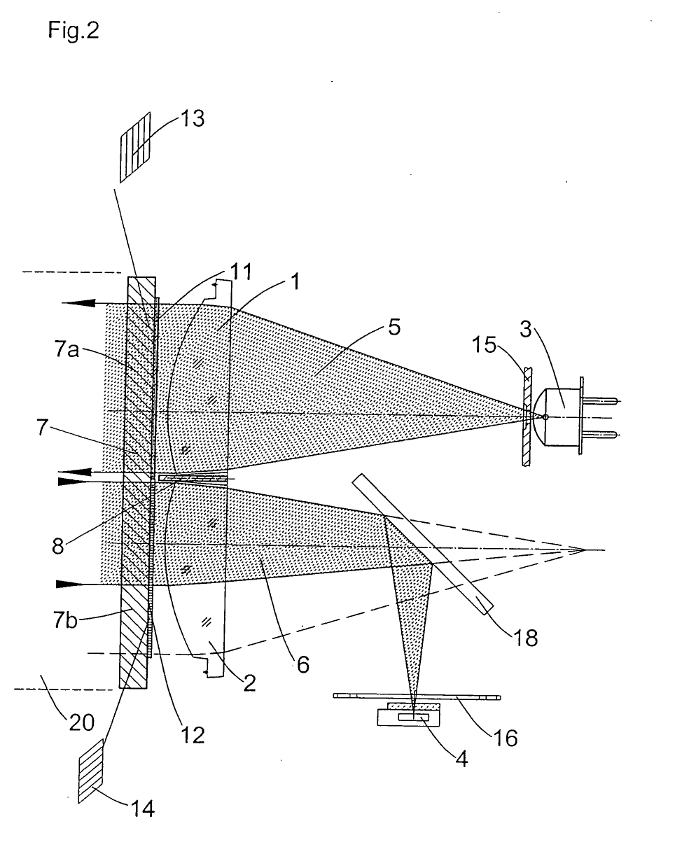

FIG. 2 a schematic depiction of a second exemplary embodiment of a reflective light barrier in accordance with the invention

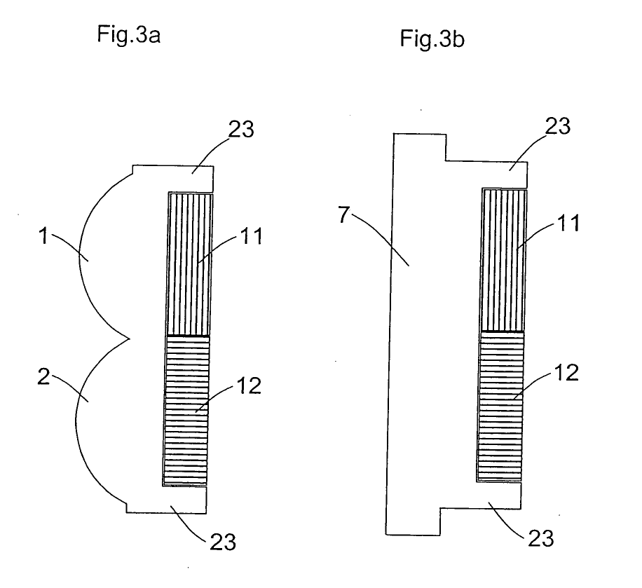

FIG. 3a a section through two polarizing filters integrated into an injection-molded part, where the injection-molded part forms two lenses

FIG. 3b a section through two polarizing filters integrated into an injection-molded part, where the injection-molded part forms a face-plate

FIG. 1 depicts a device positioned on one side of the surveillance area 20 of a reflective light barrier. The surveillance area 20 is indicated by broken lines. The device exhibits an optical transmitter 3, which consists, e.g., of a light-emitting diode and which emits a ray beam 5. This emitted ray beam 5 initially passes through an aperture 15 positioned in front of the optical transmitter. The emitted ray beam 5 is focused in a lens 1 and leaves the device through a face-plate 7, in the form of a parallel ray beam. The direction of motion of the emitted ray beam 5 is indicated in the figure by the arrow A. The emitted ray beam 5 crosses the surveillance area 20 and is reflected as an incident ray beam 6 by a reflector, which is not depicted. The incident ray beam 6 traverses the surveillance area 20 in a direction opposite to that of the emitted ray beam 5. The direction of motion of the incident ray beam 6 is indicated by the arrow B. The incident ray beam 6 passes through the face-plate 7 and into the device, and is focused onto an optical receptor 4 by a second lens 2. Positioned between the lens 2 and the optical receptor is a deflecting mirror, which deflects the incident ray beam 6, e.g., by 90°, in order to position the optical receptor and its attached electronic evaluating unit (not depicted) at a point that is spatially separate from the optical transmitter 3. Positioned in front of the optical receptor 4 is another aperture 16, which allows scattered rays to be kept out. As long as the optical receiver 4 detects the incident ray beam 6, the light barrier will indicate that no object is positioned in the surveillance area 20 of the reflective light barrier.

To detect the penetration of reflecting objects into the surveillance area 20 an initial polarizing filter 11 is positioned between the optical transmitter 3 and the lens 1, and a second polarizing filter 12 is positioned between the lens 2 and the optical receiver 4.

The lenses 1, 2 are manufactured by back-coating the polarizing filters 11, 12 in an injection-molding process. To this end, the polarizing filters 11, 12 are inserted into a tool and are coated, or back-coated, with an optically transparent material. Preferred as an optically transparent material is a plastic, particularly an easily flowing plastic, e.g., PMMA, since this material is particularly suited for use in injection-molding technology.

The polarizing filters 11, 12 will preferably take the form of polarizing foils, with an ideal thickness of 0.1 to 0.5 mm. Polarizing foils are particularly cost-effective. They obtain the necessary mechanical strength from their connection with the plastic back-coating.

Because the polarizing filters 11, 12 are back-coated they rest directly on the lenses 1, 2. The two lenses in the exemplary embodiment depicted in FIG. 1 are divided by a separating element 8. The preferred method is for the two polarizing filters 11, 12 to be back-coated together, as shown in figure. 3a. Here the two lenses 1, 2 are shaped in the same injection-molded part and thus have a defined orientation one to the other. The two polarizing filters 11, 12 also have a fixed orientation relative to each other, and this noticeably simplifies the mounting of both the polarizing filters 11, 12 and the lenses 1, 2. As a further result, the polarizing planes 13, 14 of the polarizing filters 11, 12 are also fixed in their orientation relative to each other and intersect, ideally at angle of 90°. The joint coating of the polarizing filters 11, 12 noticeably simplifies the assembly process, since it is no longer necessary to manually orient the polarizing filters 11, 12.

FIG. 2 shows the reflective light barrier in an alternative embodiment. Here identical reference numerals refer to the same parts as in FIG. 1. The second exemplary embodiment of a reflective light barrier shown in FIG. 2 differs from that of FIG. 1 only in that the first and second polarizing filters 11, 12 are back-coated, not with the optically transparent material which forms the lenses 1, 2, but with optically transparent material which forms the face-plate 7. The polarizing filters 11, 12 are thereby positioned directly on the face-plate 7, and each covers a different part 7a, 7b of the face-plate 7. This does not alter the operation of the reflective light barrier. The two polarizing filters 11, 12 are back-coated jointly and are thus integrated into the face-plate 7, with the result that the relative position of the polarizing filters 11, 12 is fixed, and thus too the polarizing planes 13, 14 relative to each other.

To protect the moisture-sensitive edges of the polarizing filters 11, 12, it is preferred not just to back-coat, but to fully coat the polarizing filters 11, 12. FIGS. 3a and 3b schematically depict this kind of fully coated polarizing filter 11, 12. FIG. 3a shows an exemplary embodiment in which the back-coated material forms the lenses 1, 2, as in the exemplary embodiment of FIG. 1, while in the exemplary embodiment shown in FIG. 3b the back-coated material forms the face-plate 7, as in the exemplary embodiment of FIG. 2. Fully coating the polarizing filters 11, 12 results in the formation of a rim 23, which encloses the edges of the polarizing filters 11, 12 and protects the latter from damage occasioned by jolts and particularly by the penetration of moisture.

### List of Reference Numerals

1 lens
2 lens
3 optical transmitter
4 optical receptor
5 emitted ray beam
6 incident ray beam
7 face-plate
7a part of face-plate
7b part of face-plate
8 separating element
11 first polarizing filter
12 second polarizing filter
13 polarization plane of first polarizing filter
14 polarization plane of second polarizing filter
15 aperture
16 aperture
18 deflecting mirror
20 surveillance area
23 rim
A travel direction of emitted ray beam
B travel direction of incident ray beam

1. A reflective light barrier, with an optical transmitter (3) positioned on one side of the surveillance area, an optical receiver (4) positioned on the same side, and a reflector positioned on the other side of the surveillance area, which reflector modifies the polarization of the light upon reflection, where at least one optical element (1, 2, 7, 7a, 7b) and one polarizing filter (11, 12) are positioned both between the optical transmitter (3) and the reflector and between the optical receiver (4) and the reflector, and where the polarization planes (13, 14) of the two polarizing filters (11, 12) intersect each other,
wherein
at least one of the two polarizing filters (11, 12) is extrusion-coated, either fully and/or on the back, with optically transparent material, such that the optically transparent material forms at least one of the optical elements (1, 2, 7, 7a, 7b).

2. A reflective light barrier according to claim 1,
wherein
both polarizing filters (11, 12) are extrusion-coated, either fully and/or on the back, with optically transparent material.

3. A reflective light barrier according to claim 2,
wherein
both polarizing filters (11, 12) are fully coated and/or back-coated jointly with optically transparent material.

4. A reflective light barrier according to claim 3,
wherein
the optical element is a lens (1, 2) or at least one portion of a face-plate (7, 7a, 7b).

5. A reflective light barrier according to claim 4.
wherein
the planes of polarization (13, 14) of the two polarizing filters (11, 12) run perpendicular to each other.

6. A reflective light barrier according to claim 5.
wherein
at least one of the two polarizing filters (11, 12) takes the form of a polarizing foil.

7. A reflective light barrier according to claim 6,
wherein
the polarizing foil has a thickness from 0.1 mm to 0.5 mm.

8. A reflective light barrier according to claim 7,
wherein
the optically transparent material is a plastic, ideally an easily flowing plastic.
